(19) United States
(12) Patent Application Publication
(10) Pub. No.: US 2014/0258464 A1
(43) Pub. Date: Sep. 11, 2014

(54) SYSTEM AND METHOD FOR ELECTRONIC DEVICE CONTROL

(71) Applicants: SONY CORPORATION, Tokyo (JP); SONY NETWORK ENTERTAINMENT INTERNATIONAL LLC, Los Angeles, CA (US)

(72) Inventors: Charles McCOY, Coronado, CA (US); True Xiong, San Diego, CA (US); Ling Jun Wong, Champaign, IL (US)

(73) Assignees: Sony Network Entertainment International LLC, Los Angeles, CA (US); Sony Corporation, Tokyo (JP)

(21) Appl. No.: 13/792,349

(22) Filed: Mar. 11, 2013

(51) Int. Cl. H04L 29/06

(52) U.S. Cl. CPC H04L 65/601
USPC 709/219

(57) ABSTRACT

An originating device is controlled by a client device by receiving a media stream from the originating device over a network at the client device. The media stream includes media content and metadata such that the metadata informs the client device of at least one function of the originating device that is available for control by the client device. A control command is transmitted in the media stream from the client device to control the at least one function of the originating device. In response, the client device receives an altered media stream over the network at the client device such that the altered media stream includes media content altered in response to the transmitted command. The altered media content can be displayed on the client device.

### BACKGROUND

1. Field of the Invention

This invention relates generally to a plurality of electronic devices, connected to the same network, communicating with each other through the network such that an input source of one device could be accessed on another device. More particularly, the present invention relates to using a single control device to control multiple electronic devices.

2. Background Discussion

Many houses have a variety of consumer electronics devices, located in different rooms of the house, which can not share content, such as television programs, music and other electronic data. Typically when a television is playing content from an input streamed source, such as through Internet Video Link IPTV (Internet Protocol Television) stream, other television devices can not be synchronized to the same place in the data stream. One conventional approach to implement this functionality has been for the user to hook-up cables for audio and video communication between rooms of the house. This conventional approach is cumbersome, expensive and does not necessarily provide the desired functionality.

### SUMMARY

Embodiments of the present invention are directed to displaying, or playing, a content stream from a network, and communicating through the stream back to the initiating device to provide control signals to the initiating device, which may change the content stream coming from the source device.

When a device, which can be controlled, sends media over a network stream, the media also may include metadata with that stream. The metadata indicates what control functions are available to a user at a client device. When a user at a client device chooses to issue one of the available control commands, the command is sent back, via the network, to the originating device, which then responds according to the command that has been given.

Accordingly, one embodiment of the present invention is directed to a method and apparatus for controlling an originating device by a client device including receiving a media stream from the originating device over a network at the client device, the media stream including media content and metadata, wherein the metadata informs of at least one function of the originating device that is available for control by the client device. A control command is transmitted in the media stream from the client device to control the at least one function of the originating device. An altered media stream is received over the network at the client device, the altered media stream including media content altered in response to the transmitted command. The client device displays the altered media content.

Another embodiment is directed to a method and apparatus for providing media content from an originating device to a networked client device. A media stream is generated by the originating device, the media stream includes media content provided by a media playback device and metadata, the metadata informs of at least one function of the media playback device that is controllable by a remote controller. The media stream is transmitted on the network. Subsequently, a control command is received on the media stream to control the at least one function of the media playback device. The media playback device is controlled in response to the received control command to alter the media stream generated by the originating device. The altered media stream includes media content altered by the media playback device in response to the transmitted control command.

Yet another embodiment is directed to a method and apparatus for controlling a client device by an originating device including receiving an initial control command. Transmitting the initial control command to the client device, the control command initiating playback from the client device. Receiving a media stream from the originating device over a network at the client device, the media stream including media content and metadata, the metadata including one or more additional control commands for controlling the client device. Selected media content is displayed on the client device based on the control command. The control command determines whether the selected media content is the media content in the media stream or media content from another source.

Yet another embodiment is directed to a method and apparatus for providing media content from an originating device to a client device, including generating a media stream by the originating device, the media stream including media content provided by a media playback device and metadata, the metadata includes a control command for controlling the client device. The media stream is transmitted on a network. The control command is an instruction for the client device to display one of either the media content in the media stream or media content from another source.

Yet another embodiment is directed to a method and apparatus for providing virtual resources through a network, including connecting one or more media playback devices to an originating device and coupling the originating device to a network. A media stream is transmitted from the originating device, the media stream including metadata identifying one or more media playback devices connected to the originating device. A control command is received on the media stream, the control command being an instruction to control a selected media playback device to provide selected media content from a selected media source. Selected media content is generated from the selected media playback device. The media stream is transmitted including the selected media content.

Yet another embodiment is directed to a method and apparatus for displaying media content from virtual resources connected to a network including coupling a client device to at least one originating device and receiving metadata on a media stream at the client device, the metadata identifying available media playback devices and available media sources on the originating device. Displaying for selection on the client the available media playback devices and available media sources and selecting a particular media playback device from the displayed available media playback devices and a particular media source from the displayed available media sources. A control command is transmitted on the media stream identifying the particular media playback device and the particular media source and receiving in response to the transmitted control command the media stream altered to include media content from the particular media playback device. The media content is displayed on the client device.

Yet another embodiment is directed to a system for linking resources through a network and includes one or more client devices coupled to the network. A receiver associated with each client device to receive a media stream from the network, the media stream including media content and metadata, wherein the metadata includes an identifier of media content available on the network. A display device associated with each client device, the display device being enabled to display the media content available from media playback devices coupled to the network and a selector associated with each client device to select one of the media content available on the network. The display device displays the selected one of the media content available on the network.

Yet another embodiment is directed to a method and apparatus for linking resources through a network including coupling a first client device to a network, the first client device having a first display. And coupling one or more media playback devices to the network, one or more media playback devices being available to media content in a media stream to the network, each available media playback device having respective media content associated therewith. Automatically detecting by the first client device the one or more available media playback devices on the network and accessing on the first client device a particular one of the respective media content.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 is a diagram of a network environment that supports a first embodiment of the present invention.

FIG. 2 is a diagram of a second embodiment of the present invention.

FIG. 3 is a diagram of a third embodiment of the present invention.

FIG. 4 is a diagram of a fourth embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media. This electronic storage media may include, for example a non-transitory electronic storage medium/media such as a register, or other electronic repository or electronic storage location for data that is capable of storing data represented in electronic form, such as bits, bytes, kilobytes, waveforms, electronic signals, digital format and other data types, formats and forms of data.

Embodiments of the present invention may be implemented using one or more processing devices, or processing modules, or facilities. The processing devices, or modules, or facilities may be coupled such that portions of the processing and/or data manipulation may be performed at one or more processing devices and shared or transmitted between a plurality of processing devices, or modules, or facilities. A module, or unit or facility, as described herein may be a memory unit, or a memory unit operatively couple, either local or remote, to a processor, either dedicated or not-dedicated, such that the module, or unit or facility can either store and/or store and process data.

The present invention may be implemented in a distributed or “cloud” computing environment in which shared resources, software and information are provided to computers and other devices over a network, which may be, for example, the Internet. “Cloud computing” typically involves delivering hosted services over the Internet. A cloud service typically has three distinct characteristics that differentiate it from traditional hosting. One characteristic is that it is sold on demand, typically by the minute or the hour; secondly, it is elastic—a user can have as much or as little of a service as they want at any given time; and thirdly, the service is usually fully managed by the provider (the consumer needs nothing but a personal computer and Internet access). Significant innovations in virtualization and distributed computing, as well as improved access to high-speed Internet have accelerated interest in cloud computing. The cloud can be private or public. A public cloud typically sells services to anyone on the Internet. (Currently, Amazon Web Services™ is the largest public cloud provider.) A private cloud is a proprietary network or a data center that supplies hosted services to a limited number of people. When a service provider uses public cloud resources to create their private cloud, the result is called a virtual private cloud. Private or public, the goal of cloud computing is to provide easy, scalable access to computing.

“Distributed computing”, or “distributed systems” relate to a system of multiple autonomous computers or processing devices or facilities that communicate through a network. The computers interact with each other in order to achieve a particular goal. A computer program that runs in a distributed system is typically referred to as a “distributed program” and “distributed programming” is the process of writing such programs. Distributed computing also refers to the use of distributed systems to solve computational problems. Typically, in distributed computing, a problem is divided into multiple tasks, each of which is solved by one or more computers. In general, distributed computing is any computing that involves multiple computers remote from each other that each has a role in a computation problem or information processing.

As used herein, a “network” is any combination of linked computers, or processing devices, adapted to transfer and process data. Networks include private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system. Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

“Server” or “server module” is one or more processors with associated memory, such as computers, or other processing devices such as a desktop computer, laptop computer, personal digital assistant (PDA), wireless handheld device, cellular telephone, or the like. Servers are capable of processing and storing data or merely capable of accessing processed and stored data from another location (i.e., both thin and fat terminals). Servers include electronic storage locations, such as RAM, ROM, EEPROM, registers and any suitable electronic storage medium that can store electronic data. The storage functionality of a server may be used to store algorithms, such as the algorithms described herein. Storage may be any suitable electronic storage, such as RAM, ROM, EEPROM, or other storage medium, or cloud-based storage using local or remote storage through a network, such as storage at a remote server.

A “content server” is a facility, or unit, that typically includes one or more processors with associated memory, such as computers, or other processing devices such as a desktop computer, laptop computer, personal digital assistant (PDA), wireless handheld device, cellular telephone, or the like. A content server is capable of processing and storing data or merely capable of accessing processed and stored data from another location (i.e., both thin and fat terminals). A content server stores electronic content, such as audio data, image data, which may include advertisement data, music data, and/or a combination thereof, media content, or the like. A content server may also access other storage databases, such as IMDB (Internet Movie Databases) as well as other electronic data.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices.

“User devices” include IPTV (Internet Protocol Television) devices, game controllers, television remote control devices, smart phones or other devices capable of playing back media.

The user devices can have memory and processing capabilities and may also access one or more computer readable storage media such as RAM-based storage (e.g., a chip implementing dynamic random access memory (DRAM)) or flash memory or disk-based-storage. Software code implementing present logic executable by the user device may also be stored on one of the memories of a user device.

A “media stream” is electronic data provided on a network. A media stream includes audio/visual (A/V) (or media) content and metadata. The metadata includes information associated with the originating device or the media playback device.

A “media source” is an electronic storage media that stores media content. A media source includes, for example a non-transitory electronic storage medium/media such as a register, or other electronic repository or electronic storage location for data that is capable of storing data represented in electronic form, such as bits, bytes, kilobytes, waveforms, electronic signals, digital format and other data types, formats and forms of data.

A “media playback device” is a device to provide a media stream from media content stored on a media source. Some media playback devices include the function of an “originating device.”

An “originating device” is an electronic device to transmit and receive a media stream over a network. Some originating devices include the function of a media playback device.

A “client device” is any device to playback media content received in a media stream. The client device includes, but is not limited to, a cellular phone, tablet, TV, computer or the like. The media stream can be received by the client device either wired or wirelessly over a network.

A “non-network-controlled” source is a device that provides media content on a media stream over the network but cannot receive commands to control the functions of the non-network-controlled source over the network. A non-network-controlled source can be either directly connected to the network or indirectly connected to the network. When indirectly connected to the network, a non-network-controlled source is connected to the network through an originating device. Commands to control the functions of the non-network-controlled source are provided by the originating device or other controller external to the non-network-controlled source.

### 1. Client Control of Streaming Content Source Devices

One aspect of the present disclosure can provide a method and apparatus for enabling a client device to control a media playback device from which the client device receives a media stream. The media playback device is a network-connected originating device or a non-network-controlled source, which both will be described as “originating device” unless a distinction need be made. The originating device transmits a media stream to the client device that includes metadata representing the controls or the functionality of the originating device that are available for a user to control. A user of the client device is enabled to operate available controls of the originating device by providing a signal to the originating device through the metadata. When an available control is operated by the user of the client device, a corresponding command is sent to the originating device through the media stream. The originating device acts on the received command that may affect the incoming media stream at the client device.

The media stream also includes media content provided by the originating device. Display of media content on the originating device is not dependent on the media content provided on the media stream. That is, the originating device can be displaying media content that is the same or different than provided on the media stream to the client or not displaying any media content at all.

In an embodiment, the media playback device can be a non-network-controlled source. The non-network-controlled source can stream data from a media source through a physical connection to an originating device, which is a networked intermediary device. The corresponding control command from the client device through the metadata can be used to operate an infrared (IR) device transmitting control signals to control the non-network-controlled source. Alternatively, control commands can be communicated to the non-network-controlled source through a physical connection to the originating device.

An aspect of the invention provides a method for controlling a media playback device through metadata present in a media stream. Device control commands can either be added to the media content in the media stream or can be transmitted in place of the media content. Based on the received control commands, a media playback device performs the instructed actions. The media playback device control commands can contain the required information regarding the source (external or internal) of the media content to be played. Some examples of such command functions are: (1) specifying the originating device to play content from internet URLs, (2) specifying an IPTV source to play the media content, and (3) specifying the originating device to show content from an internal source, such as a tuner, stored media data or disc player.

Further, other characteristics of the media playback device, such as fast forwarding or rewinding in a disc player, can also be controlled. Also, while the media playback device performs the actions instructed by the control commands, the media playback device can continue to monitor the initial media stream for further control commands from the client device.

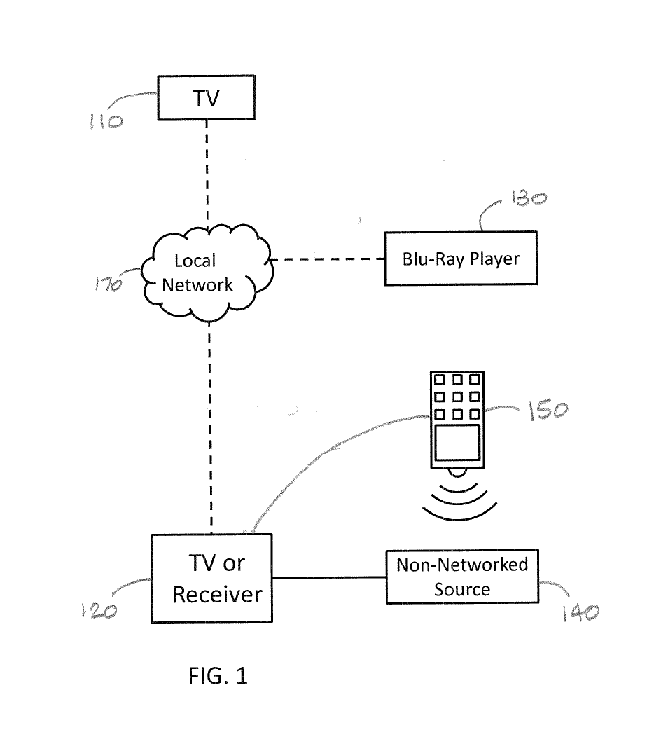

FIG. 1 illustrates an aspect of the invention for enabling a client device to control an originating device from which the client device receives a media stream. A TV 110 represents one example of a client device on which is played media content received on a media stream over a wireless local network 170. The media stream can be provided by either an originating device (which is a network connected source) 130 or a non-network connected source 140. Other examples of client devices include an audio-only device, such as a receiver, or a video-only device, such as a projector. In either case, an initial control command is provided by the originating device. The initial control command informs the client device of the command signal needed by the originating device to provide media content on the media stream.

A networked, or originating, device, such as a Blu-ray disc player or other network attached content source, is coupled directly to the local network and can stream media content output directly to the client device TV 110. The originating device 130 can be controlled directly by control commands passed back through the network stream from the client device 110.

A non-network-controlled source is one that, if not directly connected to the local network 170, is physically connected to an input of originating device such as another TV or receiver. In this case, the non-network-controlled source cannot receive control commands from the client device 110 directly over the local network. 170. The input of the originating device 120 is shared with the client device 110, for example, the TV used to display the media content. That is, the input of the originating device appears as a “virtual input” for the client device.

A control command sent through the media stream from the client device 110 to control the non-network-controlled source 140 is received by the originating device 120. Originating device 120 causes an attached IR blaster (or infrared blaster) 150 to transmit IR codes that, in turn, cause the non-network-controlled source 140 to implement the control command. An IR blaster is a device that emulates an infrared remote control to autonomously control a device that is normally controlled only by remote control key presses. The IR blaster can be attached to the originating device 120 by any known means. Alternatively, a control command can be provided to the non-network-controlled source 140 over a wired connection when the non-network-controlled source is physically connected to the originating device.

As discussed herein above, a client device can playback media content from a media stream received on a network and also communicate through that media stream back to the originating device to control the originating device, which in turn may change the media stream coming from the originating device. When an originating device that can be controlled by the client device sends media content over a network stream, the media stream can also include metadata indicating the controls of the originating device available for control by the client device. When a client device chooses to issue one of the available control commands to the originating device, the control command is sent back up the network stream to the originating device, which then reacts according to the sent control command.

In one example, a user of a client device such as a TV in one room is playing the media content on a media stream being generated by a Blu-ray player in another room. When the user actuates the “rewind” control on their remote control, the client device TV determines that the media content is being received from the media stream and, in response, forwards the rewind command as metadata back through the network connection to the Blu-ray player, which is, in this case, the media playback device. When the Blu-ray player receives the “rewind” command added to the network stream that the Blu-ray player originally initiated, the Blu-ray player acts on that command as if the command were received from its own remote control. The Blu-ray player would then rewind the playback of the disc.

When the network stream is provided from a device that is a non-network-controlled source, but is instead connected to a physical input of an originating device that is connected to the network, then the control command from the client device is transmitted up the media stream to the originating device to which the non-network-controlled source is connected. The originating device can have a coupled IR blaster that is used to send IR remote control signals to the non-network-controlled source. The originating device is programmed with the IR codes for commands that are available to control the attached non-network-controlled source. The available commands are made known to the client device receiving the media stream. Moreover, there can be privacy controls on each non-network-controlled source to disallow specified control commands from the client device or require a password before specified control commands will be acted upon.

This aspect of the invention enables a originating device sending a networked media stream to a client device to include metadata in that media stream indicating the control commands that the originating device will accept and act upon from the client device. The client device is then enabled to communicate one of the accepted control commands back up the network stream to the originating device that then acts on the received control command.

Accordingly, this aspect of the present invention can have the features including: (1) metadata in a network media stream that includes information to indicate the acceptable control command capabilities of the originating device, (2) a client device that can send control commands to the originating device back through the network used to receive the media stream, (3) originating device that sends out a media stream is operable based on input received over the network media stream, and (4) an IR blaster can be used to pass control commands received from a client device over a network connection to a non-network-controlled source.

The present invention can have the advantage that lack of physical access to control features of the originating device is overcome by sending the control commands through the same connection that is sending the media stream and received by the client device.

The originating device provides a media stream including metadata that describes the commands to which the originating device will respond. The client device receiving (and playing) the media stream is enabled to indicate to the user the acceptable control commands available to control the originating device while watching the media content being provided by the originating device. When the user issues one of the acceptable commands to an originating device, the client device can pass that control command back up the network connection to the originating device. When the originating device receives the control command through the media stream transmitted, the originating device would then respond to the command. In the case where an originating device connected to the network is receiving the media content from a non-network-controlled source device, the originating device can pass the control command to the non-network-controlled content source device through an attached IR blaster or physical connection. As such, a remote control of the client device used for playback might have buttons such as fast forward and rewind that do not directly control the client device but, rather, control the non-network-controlled device.

2. Playback Device Control through a Network Media Stream

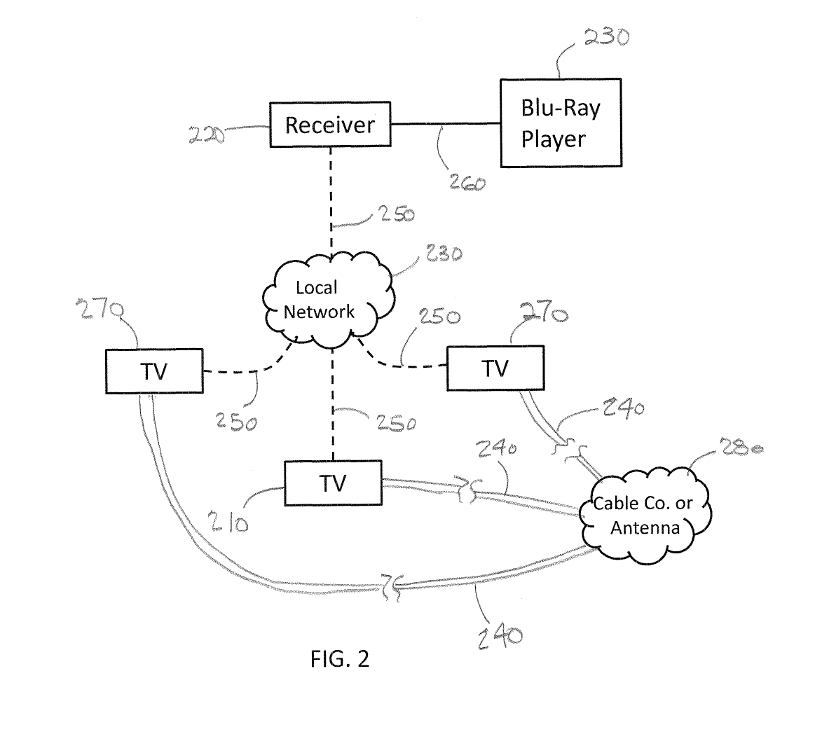

FIG. 2 illustrates another aspect of the invention that can provide an originating device sending a media stream over a network where that stream can include device control commands in addition to, or in place of, media content in that stream. When the client device playing the content stream receives a command, the client device will take actions based on received instructions. These actions may be to play content from an internal tuner, show what is being received on a physical input, or a URL to a file or stream on the internet. While the client device is executing the commands, even when the command involves playing other media or input sources, the client device is still reproducing, or playing, the original media stream and will respond to additional commands sent on that stream.

In an example, there maybe several TVs, either in different rooms in a house or distributed around an area such as a sports bar, and each of the TVs is “tuned-in” to a media stream from a controller box, which could be an audio/video receiver. The controller box would then control what each TV is displaying by sending the media content for each particular TV over the media stream. In an embodiment, the control of client devices through media streams enables each media stream to include commands in addition to or in place of media content. These commands sent over the media stream could include instructions from an originating device to:
set an internal tuner of a client device to a particular channel and show the tuner's output on the client device.
Show on the client device what is being received on a particular HDMI input of a second originating device.
Show the media content from a specified internet URL and display the media content on the client device
Fast forward through the playback of a DVD being played on a media playback device.

As shown in FIG. 2, a first client device 210 is playing media content from a controlling device 220 through, for example a wireless network 230. Controlling device 220 is an originating device that transmits the media streams in which control commands may be embedded on network 230. In the illustrated embodiment of FIG. 2, the control device is an A/V receiver. A media playback device 230, such as a Blu-ray player or the like can provide media content from a media source to the physical inputs of the controlling device 220 through, for example, an HDMI cable 260. Controlling device 220 can have the input from the media playback device displayed on first client device 210 by sending media content from the physical input in the media stream to first client device 210. An antenna connection 240 of the first client device 210 can receive media content from a cable company, broadcast network or satellite receiver 280, or other such source of media content.

First client device 210 can have an internal tuner, not shown, to receive media content that is broadcast or received through a cable and may reproduce the content decoded from the internal tuner when instructed to do so through commands in the media stream. While first client device 210 is playing the broadcast content, the client device continues to monitor the media stream on network 230.

A local network connection 250 can provide a wireless connection between electronic devices including receiver 220, first client device 210, and/or additional client devices 270. It is anticipated that network connection 250 can be extended to a connection over the internet to control far away client devices. A physical connection 260 may be provided between media playback device 230 and controlling device 220. Additional client devices 270 may also be on the network and play media content on the media stream from controlling device 220. These client devices can all be controlled independently as they all are playing a separate media streams from the controlling device. The controlling device may group client devices so that a single command issued by a user may be broadcast by the controlling device over multiple media streams to simultaneously control multiple client devices 210, 270.

In an alternative embodiment, controlling device 220 can stream all of the desired media content through itself. This includes having a client device's tuner output coupled to the controlling device instead of being built into the client device. This arrangement includes having any physical input connections be made directly to the controlling device.

As discussed above, the present disclosure includes a controlling device transmitting a media stream over a network where that stream can include client device control commands in metadata in addition to or in place of media content in that stream. The control commands are commands that are available to control the client device. The control commands may not include all of the commands that can be used to control the client device. That is, the commands available to control the client device may be limited.

When the client device receives the media stream the client device also receives the control commands. If the received command is an available command then the client device will take actions based on the received commands. These actions may be to reproduce content from an internal tuner, show what is coming in on a physical input or a URL to a file or stream on the internet, or some other available action.

While the client device is executing the commands, even when that command includes playing media content not from the media stream, the client device is still monitoring the original media stream and will respond to additional commands sent on that original media stream. This feature can allow a user to take a remote, such as for a Blu-ray player, and control the Blu-ray player through the bedroom TV when watching the Blu-ray as a virtual input on the bedroom TV by pointing the Blu-ray's remote control at the TVs remote sensor.

Accordingly, features of this embodiment include:

1. transmitting control commands from a control device in a media stream to a client device.

2. having a client device continue monitoring a media stream while playing media content from somewhere other than that media stream.

3. having a media stream to specify that the client device play content from internet URLs.

4. controlling a client device to specify an IPTV source for the client device to play.

5. controlling the client device to specify that the client device play media content from an internal source, such as a tuner or disc player.

6. controlling a media playback device to alter the media content in a media stream, such as sending commands in the media stream to have the media playback device fast forward or rewind through a disc being played by the client device playing the media stream.

The present device has the advantage of enabling the controlling device to issue commands to the client device through the network stream. This includes the ability to have the client device show media content from its own tuner, other inputs, or the internet while continuing to monitor the original media stream from the control device for more commands.

Client devices that can play a media stream from a network can be set to respond to commands received through that media stream. The client device can send metadata back up through the connection through which the media stream is received that describes what commands to which the client device will respond. When a media playback device is used to control a client device to which the media playback device is sending a media stream, the media playback device will include that command in metadata that is sent as part of the media stream. If the command instructs the client device to show something other than the media content portion of the media stream, then the media content portion of the media stream can be turned off or set, for example, to a null value that does not use bandwidth for sending media content.

3. Virtual Resources through a Local Area Network

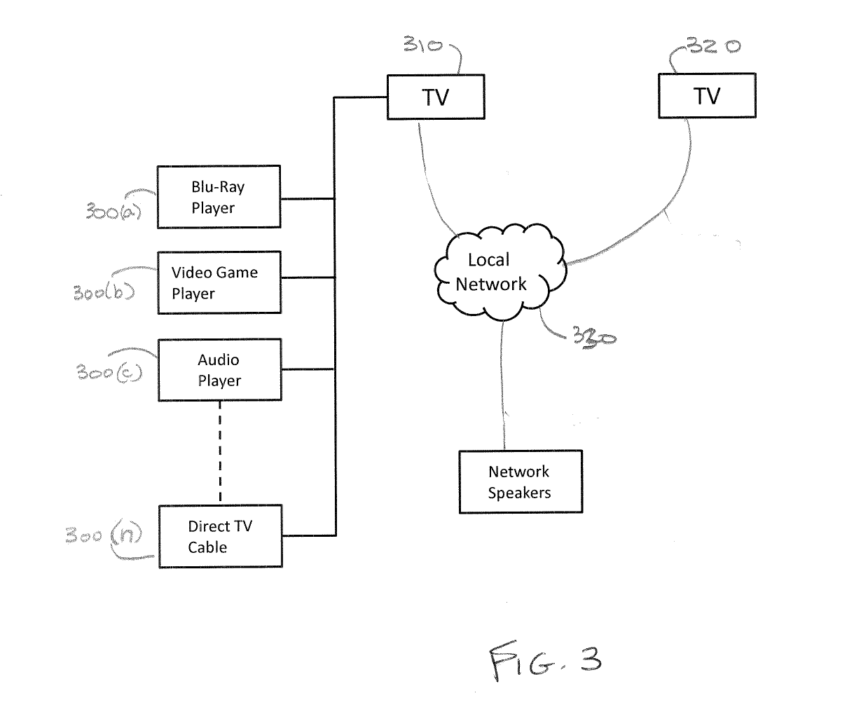

FIG. 3 illustrates another aspect of the present invention in which multiple media playback devices 300(a) . . . 300(n) are connected to a first access port (or originating device) 310, such as a TV. The sources of media content can include a DVD player, a video game player, audio player, cable TV connection or satellite TV or other media source. At least one second access port (or client device) 320 is connected through a wireless network 330 to first access port 310. All of the media playback devices may be connected to a single common access port or distributed among the access ports. Media playback devices connected to an originating device are shared with other access ports connected to the network. Network speakers also may be connected wired or wirelessly to local area network 330.

Media content from each of the media playback devices connected to the originating port 310 are available to every other client port, such as second client device 320. Moreover, media playback devices 300(a) . . . 300(n) are controllable from a second client device 320. That is, commands can be provided from second client device 320 back to originating device 310 to control the media playback devices attached thereto. For example, a second client port 320 may be displaying media content provided by a Blu-ray player attached to the originating port 310. A remote control (not shown) associated with second client device 320 can be used to provide a control command (e.g., fast forward through the media content) that is provided as metadata on the media content stream back to the originating device 210 that, in turn, provides the control command to the Blu-ray player to cause the player to fast forward through the media content.

A user of the second client device does not need to have the media playback device 300(a) . . . 300(n) physically connected thereto. That is, the media content being displayed on the second client device is not from a media playback device connected to the second client device but, rather, to the originating device and transmitted therefrom in a media stream. Unless limited by the originating device, each of the media playback devices connected to the originating device will appear as an available source of media content on the second client device. Accordingly, a user on the network can access and control a media playback device connected to a different originating device. In this way, a user need not have multiple media playback devices of a particular type connected to each client device needing the particular playback device because each playback device is available and controllable through any client device on the network.

Privacy controls can be provided in client devices so that particular media playback devices or particular media content can be blocked from being available either totally or in part to devices where a username and password is not entered. Moreover, particular control commands may be restricted in accordance with rules established by the user of a each client device.

In an embodiment, the media playback devices are available though a server cloud that is connected to an originating device. In this way a user does not have to own the media playback device but may rent usage of the media playback device through the cloud. Other users may, of course, rent the same equipment in a similar manner.

4. Virtual Device Extension through Local Area Network Linking

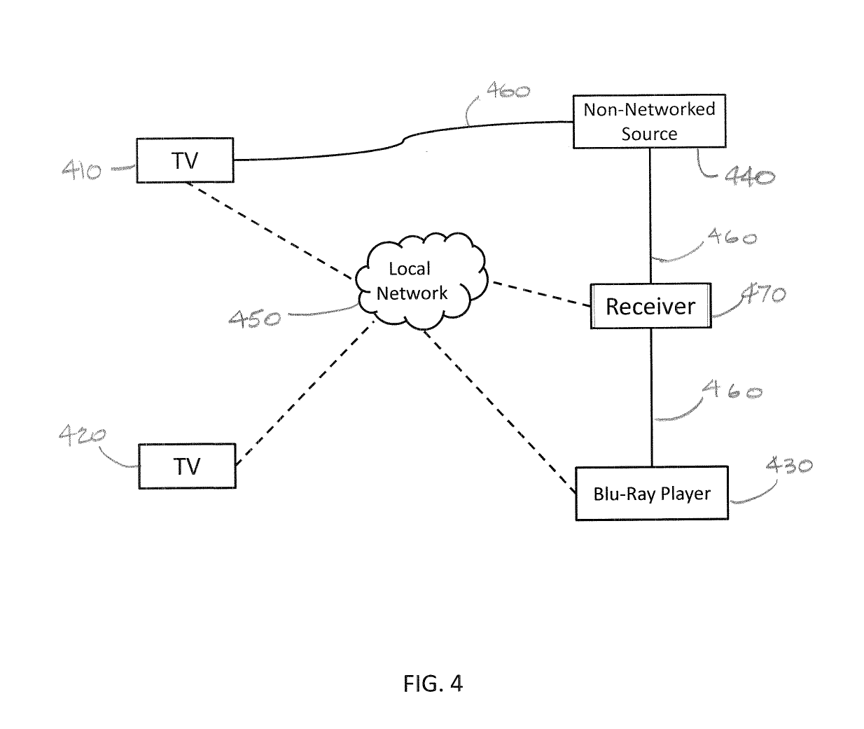

Another aspect of the invention is illustrated in FIG. 4 and includes a method and apparatus for allowing the media playback devices available at a client device to be extended to other client devices in a local network. A client device connected to a local network can automatically detect other client devices connected to the same network. Each client device is also able to access any media playback device available to other client devices in the network. Any media playback device available at a client device can be provided as a virtual input to the other client devices on the network. A single client device can act as a transmitter or a receiver for providing or receiving the virtual input. A client device can provide multiple virtual inputs with different access controls for each of them. Advantages of this embodiment may include: (1) a user of a first TV can virtually tune into a program being received on a second TV on the network, (2) a user of a first TV can access peripheral devices such as a DVR, VCR, HDMI input, etc. that are connected to a second TV on the network, and (3) a user can display the video content from a security camera or another TV as a picture-in-picture (PIP) display on his/her current screen.

FIG. 4 illustrates a virtual device extension through a local area network that includes a first client device 410, such as a TV, attached to a local network 450 and a second client device 420, such as a TV, also connected to local network 450. Either or both of client devices 410, 420 is capable of playing media content on a display. Either or both of client devices 410, 420 can be media content playback devices and the network may also include other media playback devices including, but are not limited to, the illustrated Blu-ray player 430, audio/video receiver 470 or other media playback devices connected to the local network. Note that either or both of the first and second electronics devices 410, 420 also could be media content originating devices when, for example, they receive media content from cable, satellite, antenna or other media input that can be provided to the network 450.

A non-network-controlled source 440 also can be part of the virtual device extension. The non-network-controlled source is a device that does not have a network connection, such as a video cassette recorder (VCR) and player. Non-network-controlled source 440 has a physical connection 460, such as an HDMI cable, carrying signals to an originating device, such as TV 410.

As described above, media playback devices that are connected to the same local network are enabled to communicate with each other through the network, including the streaming of media content, to appear that they were all part of one larger virtual device. Accordingly, a media playback device coupled to an input of a first client device (or the first client device itself) can be accessed on a second client device as if the input to the first client device were connected to an input on the second client device.

Each particular client device can automatically detect other client devices and media playback devices on the local network to which the particular client device can be linked. The client devices can communicate their respective capabilities to each other. Client devices and media playback devices that can provide media content can make that content available as virtual media streams to client devices. Each Client device that can receive media streams can show the media content-providing devices available on the network and enable the user to choose any of that providing device's inputs as an input source.

When a client device tunes into a virtual media stream made available by an originating device, the media content originating device begins transmitting media content from that virtual media stream to the client device over the local network. The client device can use that network media stream as if that stream were an input that is physically attached to the client device.

When the originating device is a TV, an additional virtual source may be made available, which is the stream being sent to the originating TV's display. Another client device can “tune” to this virtual source and have the same display as the originating TV, even when the originating TV changes channels or inputs.

An originating device, such as a media content receiver, having more than one physical input source to receive media content can make any number of unique virtual sources available on the local network. The receiver is enabled to control which input media source(s) is actually passed onto the network as a virtual source for a client device. In this way, many TVs may connect to unique virtual sources on a single receiver, which is connected to several physical input sources. The receiver can independently control which physical input source(s) are available to each of the client device TVs that are connected to the receiver.

In an embodiment, this aspect of the invention may be extended to have each client device be a Location-Free TV receiver and/or transmitter over the Internet at large because the devices are equipped to send and receive media streams over the Internet.

The media content streams between client devices can be encrypted when the physical media playback device indicates that the media source is protected. This can enable the media source to be protected as it would be as if all of the client devices were built into a single large housing as part of a single device instead of distributed throughout a house or area. An HDMI input indicating that the media content on that originating device should be displayed and not transmitted would be displayed by the large virtual device but not transmitted outside of the virtual device.

Privacy controls can be provided in devices so that particular media content streams can be blocked from being available either totally or partially to devices where a username and password is not entered. Similarly, each device can have settings to enable or disable all access from other devices, or to restrict access to a certain set of devices, or to require a PIN or other credentials to be entered to initiate viewing and/or source control from another device.

The device extension through a local area network can be employed in situations such as:

A user is doing something that requires them to move from room to room in their house, such as cleaning or packing. In such a case, the user could turn on media content they wish to watch in the background on the living room TV and then “tune” the other TVs in the house to the content that the living room TV is displaying. That way the user could see the same content on each TV in the house. When the channel is changed in the living room, all TVs in the house then display the new channel.

Parents watching TV in their bedroom, but tune in a second TV (or display the picture of the second TV with a “picture-in-picture” functionality of their TV, if available) to the programming being watched on the second TV in the children's bedroom to make sure the children are not watching something inappropriate.

A user having a party could play music for the party on a receiver in the living room. Other TVs and receivers around the house could be “tuned” to the media content stream that the living room receiver is playing. This would allow the same music to be heard throughout the house.

The TV in the guest bedroom can be tuned to the HDMI input of the TV in the living room where the cable box is attached to watch the output of the cable box in the guest bedroom without having to run an HDMI cable across the whole house. This is especially useful when the TV in the guest bedroom is rarely used and a monthly rental cost of a cable box can be avoided.

A previously recorded a program on the DVR in the living room can be watched in another room of the house.

An IPTV program streamed off of the internet being watched in the living room can be watched on TV in other rooms at the same time without a time lag between displays of the respective TVs. Previously there was no way to get two TVs synchronized to play back of the same point in a media content file from a network.

A user has some network connected security cameras attached to their local network (with or without microphones) and are watching a TV program and wish to monitor one of the security cameras because, for example, the user heard a noise outside the house. The user could then switch to the virtual input coming from the networked security camera on their TV and not have to get up to view the camera on a dedicated screen or the computer. The user could toggle between the camera and their TV program using a single button on their remote control. As above, the user could employ the “picture-in-picture” or “tiling” capability of the TV to watch both the program and security camera output at the same time.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method of controlling an originating device by a client device, comprising:
receiving a media stream from the originating device over a network at the client device, the media stream including media content and metadata, wherein the metadata informs of at least one function of the originating device that is available for control by the client device;
transmitting a control command in the media stream from the client device to control the at least one function of the originating device;
receiving an altered media stream over the network at the client device, wherein the altered media stream including media content altered in response to the transmitted command; and
displaying on the client device the altered media content.

2. The method of claim 1, comprising synchronizing the media content displayed on the client device with the media content displayed on another client device.

3. The method of claim 1, comprising synchronizing the media content displayed on the client device with media content displayed on the originating device.

4. A method of providing media content from an originating device to a networked client device, comprising:
generating a media stream by the originating device, the media stream including media content provided by a media playback device and metadata, wherein the metadata informs of at least one function of the media playback device that is controllable by a remote controller;
transmitting the media stream on a network;
receiving a control command on the media stream to control the at least one function of the media playback device;
controlling the media playback device in response to the received control command; and
altering the media stream generated by the originating device, wherein the altered media stream includes media content altered by the media playback device in response to the transmitted control command.

5. The method of claim 4, wherein the originating device is the media playback device.

6. The method of claim 4, comprising:
transmitting different media streams to different client devices; and
displaying on the originating device media content not being transmitted to the client devices.

7. The method of claim 4, wherein the originating device receives the media content from a media playback device that is a non-network-controlled source, and the originating device causes a remote controller to transmit codes that control the non-network-controlled source based on the received control command.

8. The method of claim 7, wherein the remote controller is an infrared blaster physically connected to the originating device.

9. A method of controlling a client device by an originating device, comprising:
receiving an initial control command;
transmitting the initial control command to the client device, the control command initiating playback from the client device;
receiving a media stream from the originating device over a network at the client device, the media stream including media content and metadata, wherein the metadata includes one or more additional control commands for controlling the client device; and
displaying selected media content on the client device based on the control command,
wherein the control command determines whether the selected media content is the media content in the media stream or media content from another source.

10. The method of claim 9, wherein media content from another source is media content received by a tuner in the client device.

11. The method of claim 9, comprising:
receiving an additional control command while the selected media content is being displayed; and
altering the selected media content displayed in response to the additional control command.

12. A method of providing media content from an originating device to a client device, comprising:
generating a media stream by the originating device, the media stream including media content provided by a media playback device and metadata, wherein the metadata includes a control command for controlling the client device; and
transmitting the media stream on a network,
wherein the control command is an instruction for the client device to display one of either the media content in the media stream or media content from another source.

13. The method of claim 12, wherein media content from another source is media content received by a tuner in the client device.

14. The method of claim 12, wherein the media content is set to a null value when the control command is an instruction for the client device to display media content from another source.

15. A method of providing virtual resources through a network, comprising:
connecting one or more media playback devices to an originating device;
coupling the originating device to a network;
transmitting a media stream from the originating device, the media stream including metadata identifying one or more media playback devices connected to the originating device;
receiving a control command on the media stream, the control command being an instruction to control a selected media playback device to provide selected media content from a selected media source;
generating selected media content from the selected media playback device; and
transmitting the media stream including the selected media content.

16. The method of claim 15, wherein the metadata identifying one or more media playback devices does not identify every media playback device connected to the originating device.

17. The method of claim 15, wherein access to one or more media sources is limited or prohibited from being a selected media source based on predetermined privacy controls.

18. The method of claim 15, wherein the network is a cloud computing network and the originating device is a server coupled to a cloud computing network.

19. The method of claim 18, wherein media playback devices connected to the server are available through the cloud computing network in response to receiving a fee.

20. A method of displaying media content from virtual resources connected to a network:
coupling a client device to at least one originating device;
receiving metadata on a media stream at the client device, the metadata identifying available media playback devices and available media sources on the originating device;
displaying for selection on the client the available media playback devices and available media sources;
selecting a particular media playback device from the displayed available media playback devices and a particular media source from the displayed available media sources;
transmitting on the media stream a control command identifying the particular media playback device and the particular media source;
receiving in response to the transmitted control command the media stream altered to include media content from the particular media playback device; and
displaying the media content on the client device.

21. A system for linking resources through a network; comprising:
one or more client devices coupled to the network;
a receiver associated with each client device to receive a media stream from the network, the media stream including media content and metadata, wherein the metadata includes an identifier of media content available on the network;
a display device associated with each client device, the display device being enabled to display the media content available from media playback devices coupled to the network; and
a selector associated with each client device to select one of the media content available on the network,
wherein the display device displays the selected one of the media content available on the network.

22. The method of claim 21, comprising synchronizing the media content displayed on each client device with the media content displayed on at least one other client device.

23. The method of claim 21, wherein access to one or more media content is limited or prohibited from being a selected media source based on predetermined privacy controls.

24. The system of claim 21, comprising one or more originating devices connected to the network, the originating devices enabled to provide the media content on the media stream.

25. The system of claim 21, comprising synchronizing media content displayed on the client device with media content displayed on the originating device.

26. The system of claim 21, wherein the originating devices transmit different media streams to different client devices, and
wherein the originating devices display media content not being transmitted to the client devices.

27. The system of claim 21, wherein each originating device includes a respective internal device to provide media content.

28. The system of claim 21, wherein the originating device receives media content for transmission on the media stream from an external source.

29. The system of claim 21, wherein the client device is enabled to select media content that is being displayed by the originating device.

30. The system of claim 21, wherein the media content displayed by the client device is independent of media content being displayed by the originating device.

31. The system of claim 21, wherein a non-network-controlled device is connected to one of the one or more originating devices.

32. An method for linking resources through a network, comprising:
coupling a first client device to a network, the first client device having a first display;
coupling one or more media playback devices to the network, one or more media playback devices being available to media content in a media stream to the network, each available media playback device having respective media content associated therewith;
automatically detecting by the first client device the one or more available media playback devices on the network;
accessing on the first client device a particular one of the respective media content.

33. The method of claim 32, wherein the accessing step comprises:
receiving on the media stream the respective media content associated with each media playback device;
displaying on the first client device the respective media content;
selecting the particular one of the respective media content;
transmitting on the media stream a control command identifying the particular one of the respective media content;
receiving in response to the transmitted control command a media stream including the particular one of the respective media content; and
displaying the particular one of the respective media content on the first client device.

34. The method of claim 32, comprising:
coupling an originating device to the network, the originating device having a display and an originating media playback device connected thereto,
wherein the originating media playback device is included in the available one or more media playback devices identified by the first client device.
coupling a second client device to the network, the second client device having a second display, wherein either or both of the first client device and the second client device is enabled to display media content on the respective display.
